(19) United States
(12) Patent Application Publication
(10) Pub. No.: US 2008/0121566 A1
(43) Pub. Date: May 29, 2008

(54) SURFACTANT FOR BITUMEN SEPARATION

(75) Inventors: Pat PAGE, Medicine Hat (CA); Jack Monkman, Medicine Hat (CA)

Correspondence Address: EDWARD YOO C/O BENNETT JONES, 1000 ATCO CENTRE, 10035 - 105 STREET, EDMONTON, ALBERTA, AB, T5J3T2, omitted

(73) Assignee: TARSANDS RECOVERY LTD., Medicine Hat, AB (CA)

(21) Appl. No.: 11/563,120

(22) Filed: Nov. 24, 2006

(51) Int. Cl. C10G 1/04; C01B 15/01

(52) U.S. Cl. 208/391; 423/584

(57) ABSTRACT

A surfactant for separating bitumen from sand includes an aqueous solution of hydrogen peroxide contacted with low rank coal and additional fresh hydrogen peroxide. The low rank coal is preferably lignite. The surfactant may be used to clean bitumen, heavy oil and/or tar from sand, shale or clay at low concentrations and with mild agitation.

### FIELD OF THE INVENTION

The present invention relates to surfactants for separating hydrocarbons from solids. In particular, it relates to a surfactant derived from low-rank coal and hydrogen peroxide for separating bitumen from sand.

### BACKGROUND

It is known to use hot water in order to separate particulate matter such as clay, sand or silt from oil and tar. However, a significant amount of oil and tar remains bound to the particulate matter after hot water treatment. Hydrogen peroxide is a known surfactant for removing oil and tar from sand, silt or clay. However, it may not be satisfactory in all cases and is often ineffective. Therefore there is a need in the art for a surfactant comprising hydrogen peroxide which may be more effective.

### SUMMARY OF THE INVENTION

The present invention is directed to a surfactant for use in separating solids from hydrocarbons. In one aspect, the invention comprises hydrogen peroxide which has been contacted with a coal. Preferably, the coal comprises low-rank coal and more preferably comprises lignite. Preferably, the hydrogen peroxide comprises an aqueous solution of hydrogen peroxide which has a concentration of about 3% to about 6% (v:v). Additional fresh hydrogen peroxide may be added to the resulting solution after contact with coal.

In another aspect, the invention comprises a method of forming a liquid surfactant and the resulting surfactant. The method may comprise the steps of mixing aqueous hydrogen peroxide with coal, allowing the mixture to stand and separating the liquid fraction from the solid fraction. The coal preferably comprises a low-rank coal. The resulting solution is then mixed with additional fresh hydrogen peroxide to form the surfactant. Surprisingly, the addition of additional fresh hydrogen peroxide improves the performance of the surfactant.

In another aspect, the invention comprises a method of separating hydrocarbons from solids comprising the step of contacting the solids/hydrocarbon with a surfactant described herein or produced by a method described herein. In one embodiment, the method comprises the steps of:
(a) mixing oilsands with fresh water to form a slurry;
(b) adding recycled process water from step (e) to the slurry;
(c) mixing the slurry with a surfactant of claim 1 to form a mixture, with or without aeration;
(d) collecting bitumen from the mixture;
(e) recovering solids from the mixture, and recovering process water;
(f) recycling process water from step (e) to step (b).

### BRIEF DESCRIPTION OF THE DRAWINGS

Embodiments of the invention are described with reference to the following drawings:

FIG. 1: Schematic representation of the process for separation of hydrocarbons, such as oil sands, from solids.

FIG. 2: Microscopic image of the decanted liquid fraction of the first component used in the preparation of the surfactant after mixing aqueous hydrogen peroxide with lignite.

FIG. 3: Microscopic image of the surfactant after addition of the second component, the additional hydrogen peroxide, to the first component in the preparation of the surfactant.

FIG. 4: Effect of chemical additives on total recovery of bitumen from Ore 2.

FIG. 5: Effect of chemical additives on total recovery of bitumen from Ore 3.

FIG. 6: Effect of chemical additives on total recovery of bitumen from Ore 4.

FIG. 7: Effect of chemical additives on total recovery of bitumen from Ore 5.

FIG. 8: Effect of chemical additives on total recovery of bitumen from Ore 6.

FIG. 9: Bitumen recovery for ore 3 as a function of time using different chemical additive conditions.

FIG. 10: Bitumen recovery for ore 4 as a function of time using different chemical additive conditions.

FIG. 11: Effect of mixing time on bitumen extraction in the first vessel at pilot plant scale from oil sands described in Table 3.

FIG. 12: Effect of mixing time on froth quality—bitumen to solids ratio, in the first vessel at pilot plant scale from oil sands described in Table 3.

FIG. 13: Conductivity analysis of samples obtained from sampling points described in Table 4.

FIG. 14: Ion analysis of samples obtained from sampling points described in Table 4.

FIG. 15: Effect of accelerant addition—amount of peroxide/lignite solution on pH of the oil sand slurry of Ore 4.

FIG. 16: Decomposition of hydrogen peroxide (H₂O₂) during the conditioning stage.

FIG. 17: Decomposition of hydrogen peroxide (H₂O₂) during the floatation.

### DETAILED DESCRIPTION OF PREFERRED EMBODIMENTS

The present invention provides for a surfactant suitable for separating hydrocarbons from particulate solids. In particular, the surfactant may be used to separate heavy oil or bitumen from sand, silt, and clay. In one embodiment, the surfactant is particularly effective to recover bitumen from oil sands. As used herein, the term “surfactant” shall include a liquid which reduces the interfacial tension between a hydrocarbon and water or a solid material, and may also encompass any material which facilitates or aids in the process of separating a hydrocarbon and water or a solid material. The liquid may be a solution or emulsion of different substances.

Bitumen is a heavy oil found in oilsands deposits such as those found in northeastern Alberta, Canada. Typical oilsands contains about 10-12% bitumen, 4-6% water, and the remaining solid fraction comprises mineral matter such as sand and clay. Without being restricted to a theory, it is believed that water forms an intermediate layer between oil which clings to a sand particle. As used herein, the term “oilsands” shall include those oil sands conventionally mined or extracted from heavy oil deposits and may also include any solid particulate matter which is contaminated or mixed with a heavy oil or hydrocarbon.

In one embodiment, a surfactant of the present invention is formed by mixed two components. The first component is the result of contacting particulate low-rank coal, such as lignite, with a dilute solution of hydrogen peroxide. The dilute hydrogen peroxide may be used in a concentration of about 3% to about 6% (v:v), although higher or lower concentrations may also be used. The coal is contacted with the hydrogen peroxide for a sufficient time, which may preferably be about 12 to about 24 hours. The length of contact time will depend on the concentration of hydrogen peroxide used and the contact temperature. The contact temperature may vary and it is not essential that it be controlled. For efficiency, the use of an ambient contact temperature is preferred. Higher concentrations and temperatures may reduce the contact time necessary to produce an efficacious product. For example, if the contact temperature is raised from 20° C. to 30° C., then the contact time may be reduced from 24 hours to about 16 hours. Also, raising the hydrogen peroxide concentration to 6% from 3% may reduce contact time to 12 hours from 24 hours at 20° C. Reasonable and minimal experimentation in this regard will easily provide one skilled in the art with effective parameters. The resulting solution contains dissolved solids from the coal, as well as suspended fine particles. In one embodiment, the resulting solution contains very little or no peroxide.

As used herein, the term “low rank coal” means coal having calorific values less than 14,000 BTU/lb on a moist, mineral-matter-free basis; and with a fixed carbon on a dry, mineral-matter-free basis of less than about 69%. The total oxygen content of low rank coals may vary in the range of about 5.0 wt. % (dry, mineral matter free basis) for bituminous coals to 35.0 wt. %, or more for lignite. Higher grades of coal may be used but are not preferred. Lignite has an average carbon content of 30%, volatile matter 27%, and heating value of 7,000 Btu per pound. The highest ranked coal, anthracite, has an average of 85% carbon, 5% volatile matter, and heating value of 12,750 Btu per pound. Sub-bituminous and bituminous coals are intermediate between these values. Without being restricted to a theory, it is believed that some portion of the volatile matter in the coal dissolves or is otherwise taken up in the aqueous solution and furthermore may be oxidized by the hydrogen peroxide solution. Therefore, it is believed that the higher proportion of volatile matter in the coal, the better results will be achieved.

Preferably, the low-rank coal is finely divided. In one embodiment, the coal is pulverized so that 100% of the material passes through a 30 mesh screen. However, one skilled in the art will recognize that finer or coarser particles may be used. If coarser particles are used, it may be necessary to increase the contact time with the hydrogen peroxide solution.

After contacting the hydrogen peroxide solution with the low-rank coal, the solid fraction is separated from the liquid fraction by any well known technique such as filtration or decanting. The liquid fraction comprises the first component.

The second component is additional hydrogen peroxide, which may be an aqueous solution of hydrogen peroxide. The first component and the second component may be mixed to form a surfactant, in a ratio of about 1:1 to about 1:10. In one embodiment, the ratio of first to second component in the surfactant is about 1:4.

The surfactant may then be diluted with water to create a surfactant solution, which may be less than about 2% surfactant in one embodiment.

While the first component is a known surfactant, as described in Applicant's co-owned U.S. Pat. No. 7,090,768, we have found that it contains little or no peroxide. It is believed that the step of contacting the peroxide with coal causes decomposition of the peroxide, while solubilizing volatile components in the coal.

The addition of peroxide as a second component surprisingly improves the performance of the surfactant in the recovery of bitumen from tar sands. Peroxide is well known for its release of oxygen gas after decomposition in aqueous media. Without being bound by a theory, it is believed components of bitumen or oil sands catalyze or cause peroxide decomposition. The formation of oxygen bubbles in-situ may enhance bitumen-bubble attachment, thereby assisting in bitumen recovery.

The dissolved organic compounds are believed to lower interfacial tensions and to increase interfacial charge. Without being restricted to a theory, it is possible that the organic compounds may stabilize the peroxide added as the second component.

The surfactant of the present invention may be used to clean hydrocarbon contaminated solids or particulate matter such as sand, silts or clay material. The contaminated material may be washed with the surfactant at an elevated temperature, preferably in the range of about 40° C. to about 80° C. Agitation is not required and only slight agitation is preferred. The simple action of transferring the solid/surfactant slurry mixture down a washing trough may provide sufficient agitation. As will be apparent to one skilled in the art, higher temperatures and longer dwell times may improve the effectiveness of the surfactant. Higher surfactant to solid ratios may also be utilized for heavily contaminated materials or materials where the hydrocarbons are tightly bound to the solid material.

The surfactant may be used at a concentration of less than 5% by volume of the solids/liquids slurry. In one embodiment, concentrations of less than about 2% and even less than 1% may be used. The inventors have found that concentrations as low as less than 0.005% may still be effective.

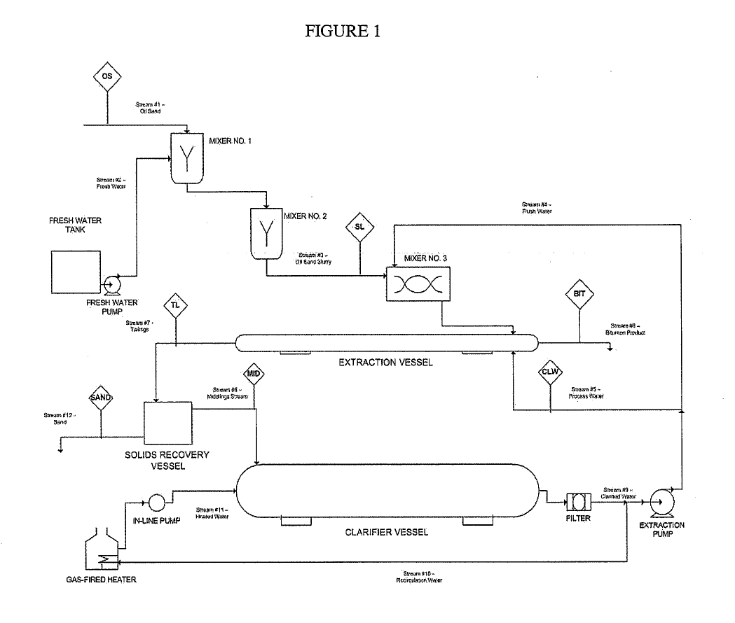

In one embodiment, the surfactant of the present invention may be used to recover bitumen from tar sands. In general terms, the method may comprise a bitumen extraction process which reuses water. A schematic representation of the process is shown in FIG. 1.

Generally, the first step in the extraction process is to form an oil sands slurry by mixing oil sands with fresh water. In one embodiment, the ratio of oil sands to water is approximately 1:1 by weight. The slurry is then diluted with recycled process water, which is obtained from a later stage, as described below. In one embodiment, the recycled water ratio to fresh water may be about 9:1. The mixture is then added to a dilute surfactant solution, which may be less than about 2% surfactant, preferably with some mild agitation in an extraction vessel. The temperature may be between about 40° C. and 80° C.

Bitumen which is released and floats to the top may then be collected from the surface of the agitation vessel, while solids will settle to the bottom and removed. The liquid fraction, which still contains suspended solids, may then be sent to a clarifying vessel, where solid/liquid separation may be achieved by filtration, centrifugal action or other known methods. The liquid portion may be used as process water and recycled to the first step in the process, to dilute the initial oil sands slurry. Preferably, the recycled water is heated to the desired temperature for the operation as it is being returned to the process.

### EXAMPLES

The examples below are carried out using standard techniques, which are well known and routine to those skilled in the art, except where otherwise described in detail. These examples are intended to be illustrative, but not limiting, of the invention.

### Example 1

### Preparation of the Surfactant

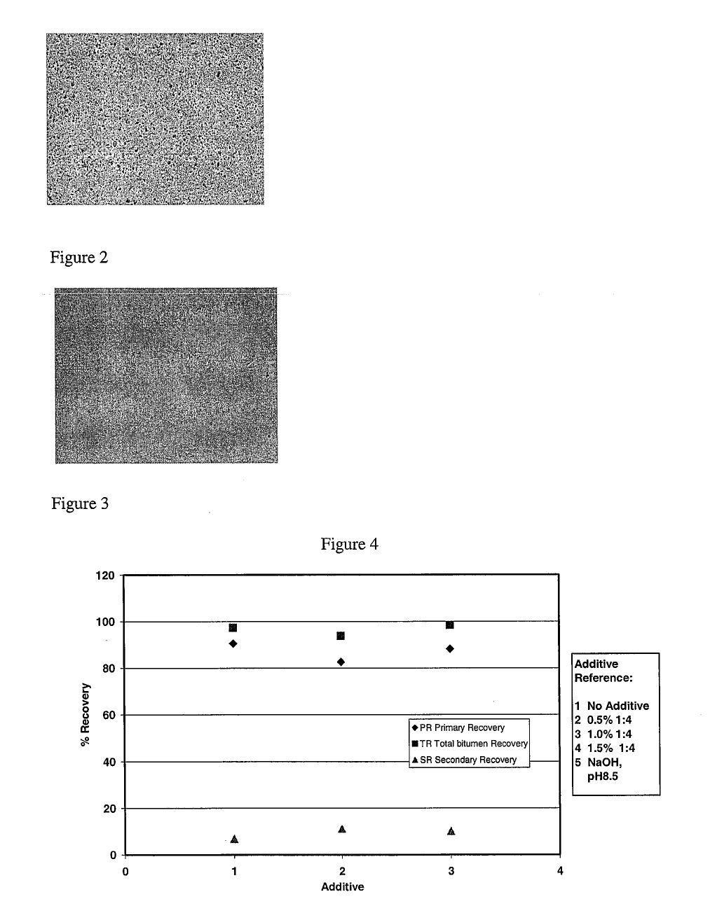

3 volumes of 3% hydrogen peroxide was well mixed with 1 volume of lignite particles which were screened with a 30 mesh screen. The mixture was allowed to stand for 24 hours at 20° C. The liquid fraction was decanted and found to contain about 10% total suspended solids by weight, which may be seen in the microscopic image shown as FIG. 2. The total solids in the first component was found to be about 18.3% by evaporating the first component entirely. The liquid fraction was found to contain less than 0.01% peroxide.

The liquid fraction was mixed with hydrogen peroxide in a ratio of 1:4 to produce the surfactant. As seen in FIG. 3, very little suspended solids may be seen in the surfactant, indicating that the addition of hydrogen peroxide has caused the suspended solids in the first component to dissolve. The surfactant had a pH of 2.60, indicating that acidic components of the lignite had dissolved.

### Example 2

### Batch Extraction using Syncrude BEU and Low Consistency Hydrotransport

Both Syncrude Batch Unit Extraction (BEU) and Low Consistency Hydrotransport loop were used, with the extraction temperature controlled at 55° C. The performance of the surfactant was compared with conventionally used caustic process.

For these tests, six different types of oil sands samples were obtained. The samples were homogenized and the bitumen, solids and water content were determined. The analyses for these samples are shown in Table 1.

TABLE 1
Composition of Oil Sands Samples

| | Bitumen | Solids | Water |
|---|---|---|---|
| Sample ID | (wt. %) | (wt. %) | (wt. %) |
| Ore 1 | 14.65 | 84.56 | 0.79 |
| Ore 2 | 7.99 | 86.18 | 5.75 |
| Ore 3 | 12.55 | 84.89 | 1.94 |
| Ore 4 | 8.87 | 87.65 | 3.43 |
| Ore 5 | 15.24 | 83.07 | 1.59 |
| Ore 6 | 10.23 | 83.99 | 5.45 |

A preliminary set of experiments were conducted using the Syncrude BEU, conducted as follows:
1. Remove homogenized oil sand from freezer and allow to thaw and reach room temperature
2. Set heating bath to 55° C. (or desired temperature) and circulate through BEU heating jacket
3. Prepare 41 mixture of 85% toluene/15% isopropyl alcohol (EPA) (Toluene/IPA mix)
4. Heat approximately 2000 ml Edmonton tap water to ˜58° C.
5. Transfer 110 ml-heated water to the BEU unit
6. Weight 500 gm of oil sand to the nearest 0.1 g and add to water in BEU
7. Turn motor on to 600 rpm, raising and lowering motor and impeller assembly to break any lumps if necessary, leaving the impellor at the set position (20 mm from the bottom of pot)
8. Turn on air to 420 ml/min
9. Start timer for 10 minutes
10. When complete, turn off air and flood the mixture with 800 ml of heated water
11. Mix for 10 minutes at 600 rpm—no air
12. When complete, skim off primary froth into a pre-weighed bottle using a flat edged spatula, cleaning the spatula and BEU surface with a pre-weighed tissue, which is placed in froth bottle and weighed. Submit froth sample for Dean Stark Analyses (include tissue weight to be removed from solids weight).
13. Mix the remaining material for 5 minutes at 780 rpm with air addition of 234 mL/min
14. When complete, skim off secondary froth in the same manner as the primary froth and submit sample for Dean Stark analysis.
15. Place a pre-weighed 2-liter jar under BEU and turn impeller on. Take out bottom plug of BEU, turn impeller off and allow mixture to drain into jar (occasionally starting and stopping the impeller during this procedure allows the solids to mix better and flow out). Raise impeller and scrape as much sample as possible into the jar. Remove jar and retain for analyses if required.
16. Place a pre weighed 250 ml jar under the BEU.
17. Lower the impeller and slowly stir.
18. While washing with toluene/IPA mix slowly raise the impellor to just below the top of BEU and stop motor.
19. Raise the motor and impeller.
20. Wash pot and impeller with toluene/IPA mix, collecting residuals in jar. Wipe with a pre weighted tissue and place in jar. Submit toluene wash for analysis (bitumen weight to be combined with primary froth weight).
21. Put bottom plug back in place
22. Turn off air and heating bath.

Results were calculated as follows:

Primary Recovery %: ((Wt. of bitumen in primary froth+Wt. of bitumen in toluene wash)/(Wt. of oil sand used*% bitumen in oil sand*0.01))*100

Secondary Recovery %: ((Wt. of bitumen in secondary froth*100)/Wt. of oil sand used*% Bitumen in oil sand*0.01))*100

Total Bitumen Recovery %: Primary Recovery+Secondary Recovery

Scavenging Efficiency: ((Secondary Recovery*100)/(100−Primary Recovery)

Primary Froth Quality: % Bitumen in Primary Froth

Secondary Froth Quality: % Bitumen in Secondary Froth

Total Froth Quality: (Wt. of bitumen in Primary Froth+Wt. of bitumen in Secondary Froth)*100/(Wt. of Primary Froth+Wt. of Secondary Froth)

Froth Quality can also be calculated for % Solids and % Water

The oil sand extraction test loop is used to extract bitumen froth from oil sand to determine extractability based on ore quality and variable test conditions. A simulation of a slurry transport loop was conducted as follows:
a) Turn on heating bath (1/0 button) and set to run temperature
b) Start heating ˜6 liters of process water on a hot plate to run temperature
c) Fill system with heated process water
d) Turn on pump
e) With separation vessel base baffle open, note time, and slowly add weighed oil sand to system
f) Start air addition (if required),
g) Skim froth from top of separation tank into preweighed jars at set times until completion of run
h) Stop air addition

The water used in these experiments was Edmonton tap water. Extractions were conducted in water, with increasing concentrations of the surfactant (expressed as wt. % in water) or caustic, which was added until a pH at the flood stage reached a value of 8.5. The surfactant had the first and second components combined in a 4:1 ratio. The results of these experiments are listed in FIGS. 4 to 8.

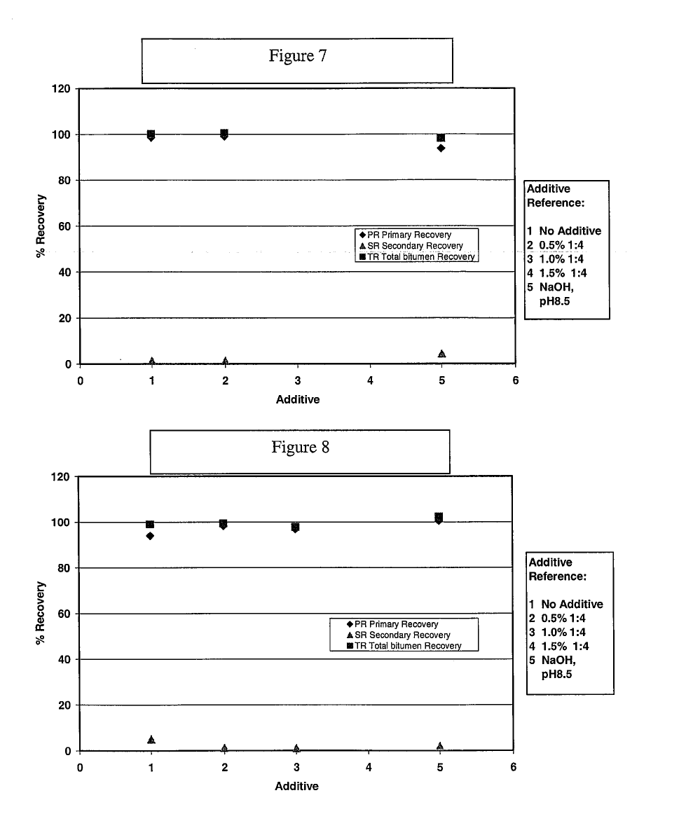

Changes to primary and total recovery are often used to evaluate the effect of chemical addition on bitumen extraction. For Ore 2 (FIG. 4), a 90% primary recovery was obtained in the absence of chemical aids, suggesting that the ore can be easily processed. Adding chemicals did not show any benefit to improve the recovery. For the ore samples of Ore 5 and 6 (FIGS. 7 and 8), both primary and total recoveries approached 100%, no matter whether the chemical aids were added or not. The results suggest that for these three types of ores, addition of any process aid would have little benefit.

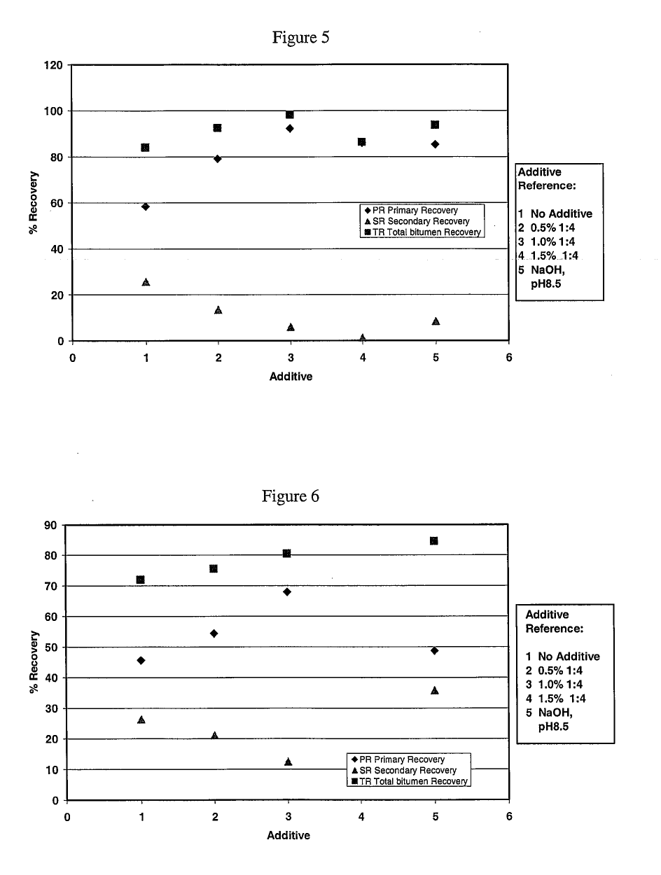

The use of the surfactant improved bitumen recovery for Ore 3 and 4 (FIGS. 5 and 6). For Ore 3, the primary bitumen recovery increased from 58%, without chemical aids, to 92% with the addition of 1.0% surfactant. In this case, the performance was even better than adding caustic (85% recovery). For Ore 4, the primary bitumen recovery increased from 46%, without surfactant, to 67% with the addition of 1.0% surfactant. For this specific ore, adding caustic did not boost the primary recovery, but increased the total bitumen recovery to about 85% by increasing the secondary recovery. The low bitumen recovery for these two ores without chemical aids was related to their ore characteristics, which was described as having ‘high fines and mud content’. The results suggested that for all these ore samples tested, Ores 3 and 4 would be difficult to process and would require the use of a process aid.

To aid in further quantification of the effect of the surfactant, Ores 3 and 4 were tested in the lab extraction loop system.

The advantage of using this laboratory apparatus is the kinetic information that is obtained on the recovery of the bitumen. The extraction loop has an additional advantage of simulating the oil sands slurry conditioning in hydrotransport pipelines.

To evaluate and predict the effect of chemical additives on bitumen extraction performance, a first order kinetic model shown below was used to fit the experimental data:

R=R_{∞}*(1−e^{-kt})

where R and R_{∞} are bitumen flotation recovery at time t and time infinity (R_{∞}≦100%) and k is a flotation rate constant (min⁻¹). The larger the rate constant k, the faster the bitumen flotation, and the higher achievable bitumen recovery at a given flotation time. Flotation rate constant is a valuable parameter for the process diagnosis, development and scale-up. For example, if the bitumen extraction process is targeted and designed at 90% recovery, and the bitumen flotation rate constant for a given ore with chemical additives is known, then the required retention time of the ores in the process, and the size of the separation tank can be determined logically. Such exercise could contribute to enormous savings in reducing the operating and capital costs.

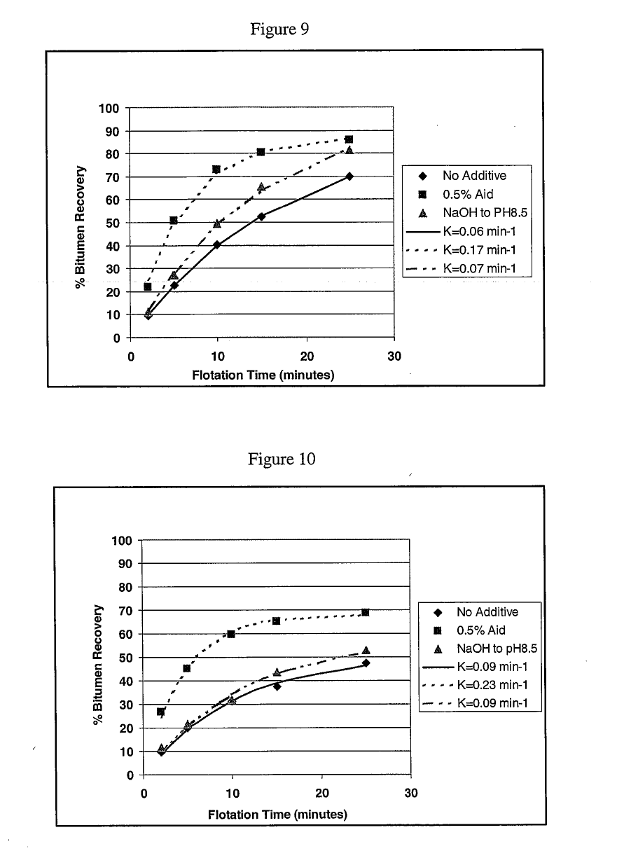

FIGS. 9 and 10 show the bitumen recovery, for ores 3 and 4, respectively, as a function of time for different chemical additive conditions. For ore 4, the use of the surfactant resulted in an increase in overall recovery from a value of 50% with water or caustic to 70%. For both ores, however, a significant increase in bitumen recovery rate with time was observed with the addition of 0.5% surfactant compared to either water or caustic. While virtually no changes in bitumen flotation rate constant were observed when adding caustic, the flotation rate constant almost tripled with the addition of 0.5% surfactant, as compared with the case without chemical addition.

The good fit of the experimental results with the model prediction suggested that the increased bitumen flotation kinetics due to the surfactant could be either due to the enhanced bitumen-bubble attachment or the increased total amount of bubbles in the system. The loop tests demonstrated again that addition of the surfactant was beneficial for recovering bitumen from poor processing ores, and the added chemicals performed better than caustic in increasing bitumen recovery.

### Example 3

### Pilot Plant

In a pilot plant having a flowsheet schematically represented in FIG. 1, extraction followed three steps: oil sand was slurried at a 1:1 ratio in two sequential vessels, followed by a separation vessel, and a water recovery loop. The first runs were conducted to commission the introduction of oil sand into this system, and to determine the optimum mixing time for the slurry preparation. Water used in these runs was Medicine Hat city water. The characteristics of the oil sand used are listed in Table 3.

TABLE 3
Oil sand used in Commissioning Pilot Runs

| | |
|---|---|
| % Bitumen | 8.1 |
| % Water | 24.4 |
| % Solids | 68.2 |

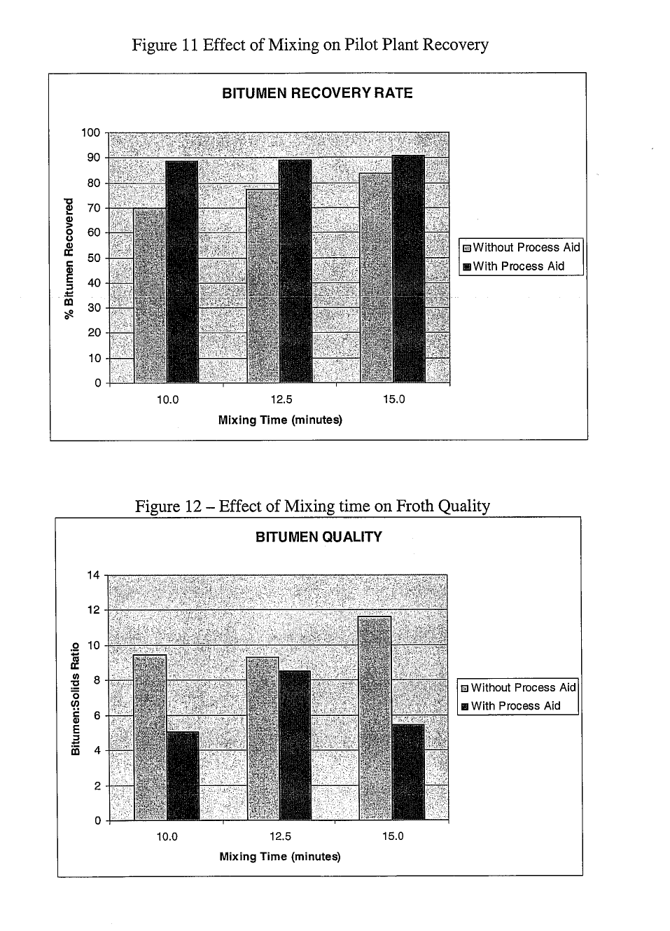

FIG. 11 shows the effect of mixing time in the first vessels on bitumen extraction. As can be seen, consistently higher bitumen recoveries were obtained with the addition of the TRL process aid, confirming lab test results. It can also be noted that with the addition of process aid, bitumen recovery did not change with mixing time, but an increase in bitumen recovery was observed with increasing mixing time in the absence of process aid. In subsequent experiments, a 15 minute mixing time was adopted.

Another significant finding is that the bitumen froth quality (determined as the bitumen/solids ratio) was much higher in the piloting tests than those from lab tests. In the case of lab tests, all the tests (both BEU and loop tests) showed that bitumen to solids ratio in the froth was less than 2. However, for the piloting tests as shown in FIG. 12, bitumen to solids ratio in the froth was much greater than 4. In the case of no process aid addition, the ratio was even greater than 9 to 11. It should be noted here that for commercial operation the bitumen to solids ratio in the froth is around 4-6. Since most solids that report to the froth are carried over by the water film with rising air bubbles, or by attachment to the bubbles, the low solids in the froth could be attributed to a low amount of entrained air (no air added) used in the piloting tests. This observation is in agreement with the first findings of Dr. Karl Clark (founder of the hot water extraction process) that aeration should be controlled in the narrow ranges to have a good froth quality. In addition, the strong mechanical agitation and hydrodynamic conditions used in lab tests could also contribute to more solids carried over to the froth.

### Example 4

### Water Analysis

As part of the evaluation of the water recycle system, water samples were taken and analysed for changes in suspended solids, pH and several ions. These results are also described below. In the runs that were conducted in this phase of piloting, very few changes in water quality were observed. It was suspected that the very large water to oil sand ratio in the extraction/water clarification system (approximately 50:1) was responsible.

Seven different samples were taken around the process. The sampling protocol is listed in Table 4. The location of where the specified sample was taken is illustrated in FIG. 1.

TABLE 4
Sampling points and sampling time for analysis of water re-cycled in the
bitumen separation process.

| | Sample Number | | | | | | | Process | |
|---|---|---|---|---|---|---|---|---|---|
| | Oil | Oil | | | | | | Temperature | |
| | Sands | Sands | | | Clarified | | | (° C.) | |
| Time | Ore | Slurry | Tailings | Middlings | Water | Bitumen | Sand | Extraction | Clarifier |
| (min) | (OS1) | (SL1) | (TL1) | (MD1) | (CLW1) | (BIT1) | (SD1) | Vessel | Vessel |
| 0 | 0 | 0 | | 0 | 0 | | | 52 | 54 |
| 10 | | | 1 | 1 | 1 | 1 | | 51 | 54 |
| 13 | | 1 | | | | | | | |
| 20 | | | 2 | 2 | 2 | 2 | | 51 | 53 |
| 23 | | 2 | | | | | | | |
| 30 | | | 3 | 3 | 3 | 3 | | 50 | 54 |
| 35 | | | | | | | | | |
| 40 | | | 4 | 4 | 4 | 4 | | 51 | 53 |
| 50 | | | 5 | 5 | 5 | | 0 | 52 | 54 |

The bitumen recovery for this process was determined by doing a material balance around the Extraction Vessel. The data in this example was for Run No. 10:
1) Known feed rate of oil sand to the vessel (181.44 kg/hr).
2) Known composition of oil sand (8.34% bitumen, 85.05% solids, 6.60% water).
3) Known fresh water addition to oil sand feed (218 kg/hr).
4) Known composition of bitumen product stream from the Extraction Vessel (32.97% bitumen, 16.23% solids).
5) Known composition of tailings stream from the Extraction Vessel (0.10% bitumen, 6.71% solids).
6) Assume no accumulation of bitumen, water, or solids in Extraction Vessel.

The following unknowns are identified as:

Xb=bitumen in the bitumen product stream (kg/hr)

Xs=solids in the bitumen product stream (kg/hr)

Xw=water in the bitumen product stream (kg/hr)

Yb=bitumen in the tailings stream (kg/hr)

Ys=solids in the tailings stream (kg/hr)

Yw=water in the tailings stream (kg/hr)

The following equations are the material balance:

Xb+Yb=15.13 kg/hr Bitumen In =Bitumen Out

Xs+Ys=154.31 kg/hr Solids In =Solids Out

Xb/(Xb+Xs+Xw)=32.97% Bitumen Content of Bitumen Product

Xs/(Xb+Xs+Xw)=16.23% Solids Content of Bitumen Product

Yb/(Yb+Ys+Yw)=0.10% Bitumen Content of Tailings Stream

Ys/(Yb+Ys+Yw)=6.71% Solids Content of Tailings Stream

The solution of the six unknowns and six equations gives:

Xb=12.93 kg/hr

Xs=6.36 kg/hr

Xw=19.91 kg/hr

Yb=2.20 kg/hr

Ys=147.95 kg/hr

Yw=2054.73 kg/hr

### Bitumen recovery=12.93/15.13=85.4%

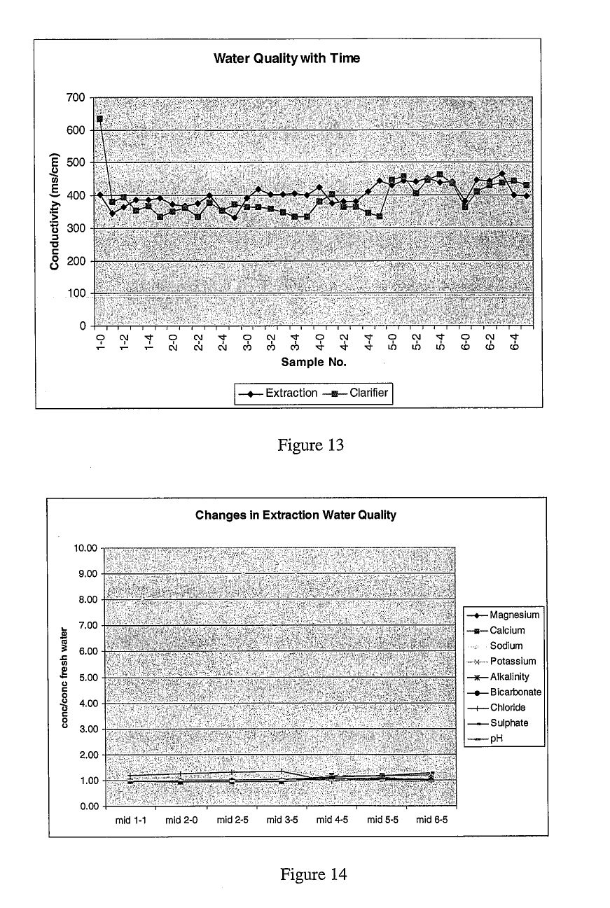

During the commission runs, sample of the recycle water were taken and subjected to analysis in order to evaluate the change in water quality with time. FIGS. 13 and 14 shows the conductivity (a measure of the soluble ion content) and the ion analysed for water recovered from the ‘middlings’ sample. The ion analysis is presented as the concentration in the sample, normalized by the concentration in original water (see Table 5 for original water analysis). For the most part, there was very little change in the quality of the water. Although the sodium content did increase by a factor of 8, the absolute concentration (16 ppm) was relatively small.

TABLE 5
Ion Analysis of Medicine Hat City Water

| | | | |
|---|---|---|---|
| Calcium | 40.2 | Chloride | 9.86 |
| Magnesium | 14.5 | Sulfate | 60.9 |
| Sodium | 1.8 | Alkalinity | 124.1 |
| Potassium | 1.8 | Bicarbonate | 148.2 |
| pH | 7.23 | | |

### Example 5

### Decomposition Experiments

The effect of peroxide addition on the changes in oil sands slurry properties was examined.

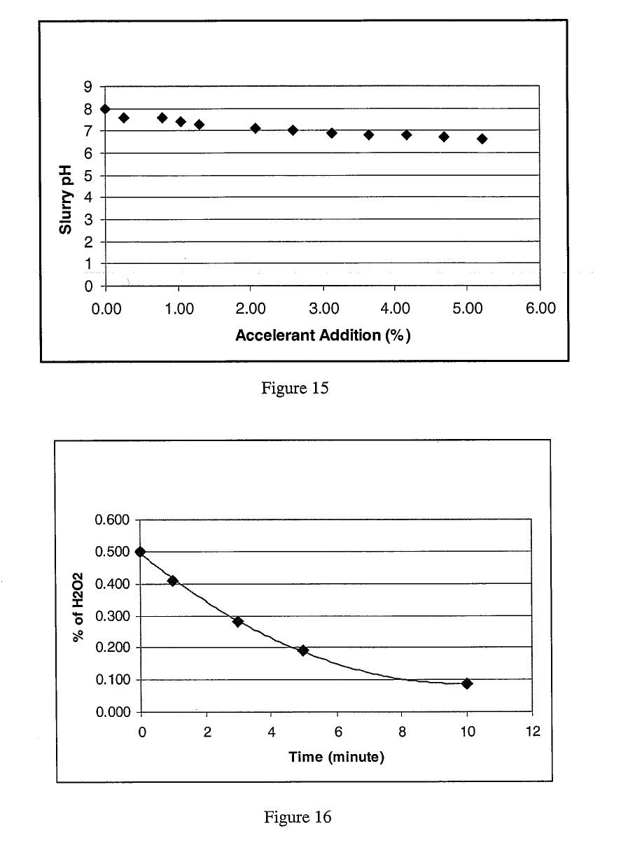

FIG. 15 shows the changes of slurry pH with the amount of peroxide/lignite solution addition. In this test, 200 gm of ore (sample Ore 4) was mixed with 383 ml of water at 55° C. The amount of peroxide/lignite solution added was based on the water content. As can be seen, the slurry pH decreased with increasing peroxide/lignite solution addition. A possible consequence of the reduced slurry pH in terms of oil sands processability is that the fine solids could have a higher probability to coagulate with bitumen, thereby contributing to increased solids content in the bitumen froth.

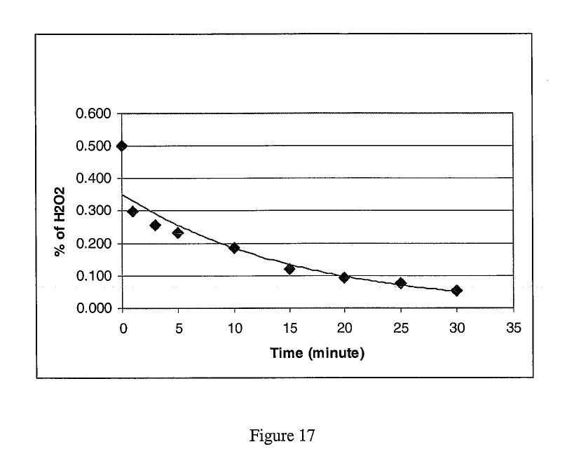

The decomposition of hydrogen peroxide in the presence of oil sand slurry was also evaluated. The test conditions were set to simulate conditioning (1:1 oil sand:water and flotation (1:2 oil sand:water). Samples were removed from the slurry and the hydrogen peroxide concentration determined by Raman spectroscopy. The results in FIGS. 16 and 17 show that more than 90% peroxide was decomposed within 10 min at the conditioning stage. The decomposed hydrogen peroxide could be converted to the generation of oxygen gas, forming oxygen bubbles in the oil sands slurry. Without being restricted to a theory, it is believed that this contributes to the enhanced bitumen recovery by adding the two-part surfactant of the present invention.

It can also be noted that the peroxide decomposition was faster during the conditioning stage than in the flotation stage. One of the possible reasons could be due to much higher solids to water ratio during conditioning stage, thereby contributing to a stronger catalytic effect of solids on the peroxide decomposition.

What is claimed is:

1. A surfactant for use in separating hydrocarbons from oilsands, comprising a first portion of aqueous hydrogen peroxide which has been contacted with coal, and a second portion of hydrogen peroxide.

2. The surfactant of claim 1 wherein the coal comprises low-rank coal.

3. The surfactant of claim 2 wherein the low-rank coal is lignite.

4. The surfactant of claim 3 comprising between about 3% to about 6% hydrogen peroxide.

5. The surfactant of claim 1 wherein the volume ratio of the first portion to the second portion is between about 1:1 to about 1:10.

6. The surfactant of claim 1 wherein the volume ratio of the first portion to the second portion is between about 1:3 to about 1:4.

7. A method of separating hydrocarbons from oil sands, comprising the steps of contacting the oilsands with a surfactant of one of claims 1-6.

8. The method of claim 7 wherein the solids/hydrocarbon is contacted with the surfactant with no or mild agitation.

9. The method of claim 8 wherein the contacting step is performed at between about 40° C. and 80° C.

10. A method of processing oilsands, comprises the steps of:
(a) mixing oilsands with fresh water to form a slurry;
(b) adding recycled process water from step (e) to the slurry;
(c) mixing the slurry with a surfactant of claim 1 to form a mixture, with or without aeration;
(d) collecting bitumen from the mixture;
(e) recovering solids from the mixture, and recovering process water;
(f) recycling process water from step (e) to step (b).

11. The method of claim 10 wherein step (c) occurs at a temperature between about 40° C. and 80°.
